(19) United States
(12) Patent Application Publication
(10) Pub. No.: US 2019/0301887 A1
(43) Pub. Date: Oct. 3, 2019

(54) NAVIGATION DEVICE AND NAVIGATION METHOD

(71) Applicant: Mitsubishi Electric Corporation, Tokyo (JP)

(72) Inventor: Daiki KUDO, Tokyo (JP)

(73) Assignee: Mitsubishi Electric Corporation, Tokyo (JP)

(21) Appl. No.: 16/465,525

(22) PCT Filed: Dec. 22, 2016
(86) PCT No.: PCT/JP2016/088449

§ 371 Date: May 30, 2019

(51) Int. Cl. G01C 21/36; G11B 27/19; G11B 27/031; G06F 16/787; G06F 16/29; G06F 16/738

(52) U.S. Cl. CPC G01C 21/3647; G11B 27/19; G11B 27/031; G06F 16/738; G06F 16/787; G06F 16/29; G01C 21/3623

(57) ABSTRACT

A navigation device includes: a destination receiving unit for receiving information indicating a destination; a content searching unit for searching for video content related to the destination based on the information indicating the destination depending on the information indicating the destination received by the destination receiving unit; a selection receiving unit for receiving information on video content selected from among the video content searched for by the content searching unit; a route searching unit for searching for a guidance route to the destination using a location related to the video content received by the selection receiving unit as a waypoint; and an output processing unit for outputting the guidance route searched for by the route searching unit and outputting the video content received by the selection receiving unit during output of the guidance route.

### TECHNICAL FIELD

The present invention relates to a navigation device capable of providing video content to a user.

### BACKGROUND ART

A navigation device is a device that performs route guidance to a destination to a moving object using the global positioning system (GPS) and the like.

Some navigation devices have, for example, a function of playing back video content in addition to the function of performing route guidance.

In a navigation device having a function of playing back video content, as a technique of using video content that can be played back by the navigation device, for example, Patent Literature 1 discloses a technique of displaying area information or spot information as a video on a screen for a user to select an area or a spot which is to be a destination or a waypoint.

### CITATION LIST

### Patent Literature

Patent Literature 1: JP 2013-113674 A ([0082] etc.)

### SUMMARY OF INVENTION

### Technical Problem

However, the navigation device disclosed in Patent Literature 1 merely uses video content that can be played back by the navigation device as information that is supplementarily provided when a user selects a destination or the like. As described above, there is a problem in which the conventional navigation device cannot provide information obtained by effectively utilizing video content that can be played back by the navigation device to a user moving on a guidance route.

The present invention has been made to solve the above problem and aims to provide a navigation device capable of providing information obtained by effectively utilizing video content that can be played back by the navigation device to a user moving on a guidance route.

### Solution to Problem

A navigation device according to the present invention includes: a destination receiving unit for receiving information indicating a destination; a content searching unit for searching for one or more pieces of video content related to the destination based on the information indicating the destination depending on the information indicating the destination received by the destination receiving unit; a selection receiving unit for receiving information on one piece of video content selected from among the one or more pieces of video content searched for by the content searching unit; a route searching unit for searching for a guidance route to the destination using one or more locations related to the video content whose information is received by the selection receiving unit as waypoints; and an output processing unit for outputting the guidance route searched for by the route searching unit and outputting the video content whose information is received by the selection receiving unit during output of the guidance route.

### Advantageous Effects of Invention

According to the present invention, it is possible to provide information obtained by effectively utilizing video content that can be played back by the navigation device to a user moving on the guidance route.

### BRIEF DESCRIPTION OF DRAWINGS

FIG. 1 is a configuration diagram of a navigation device according to a first embodiment of the present invention.

FIG. 2A and FIG. 2B are diagrams each showing an example of a hardware configuration of the navigation device according to the first embodiment of the present invention.

FIG. 3 is a flowchart illustrating operation of the navigation device according to the first embodiment of the present invention.

FIG. 4 is a flowchart illustrating details of operation of a content searching unit in step ST302 of FIG. 3.

FIG. 5 is a flowchart illustrating details of operation of a route searching unit in step ST305 of FIG. 3.

FIG. 6 is a flowchart illustrating details of operation of a content playback unit in step ST306 of FIG. 3.

FIG. 7 is a configuration diagram of a navigation device according to a second embodiment of the present invention.

FIG. 8 is a flowchart illustrating operation of a route searching unit in the second embodiment.

FIG. 9 is a flowchart illustrating operation of a content playback unit in the second embodiment.

FIG. 10 is a diagram showing an outline of a navigation system in a third embodiment of the present invention.

### DESCRIPTION OF EMBODIMENTS

Hereinafter, embodiments of the present invention will be described in detail with reference to the drawings.

### First Embodiment

A navigation device 10 according to the first embodiment of the present invention will be described below as used in an in-vehicle navigation device that performs route guidance to a vehicle as an example.

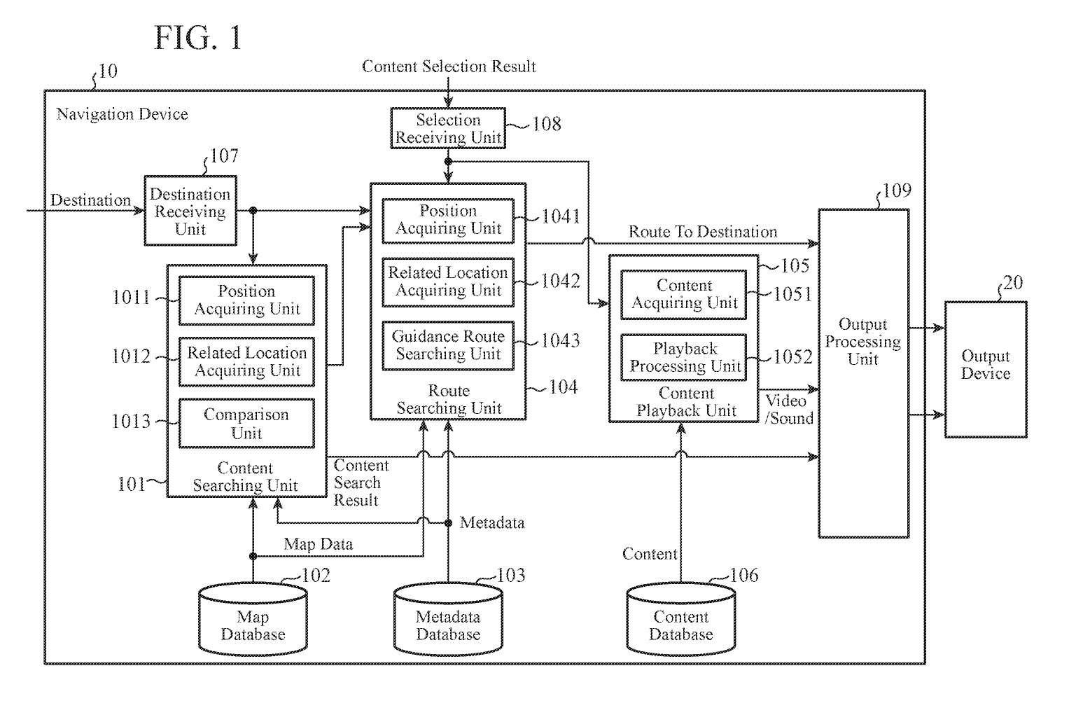

FIG. 1 is a configuration diagram of the navigation device 10 according to the first embodiment of the present invention.

The navigation device 10 is connected to an output device 20. The output device 20 is, for example, a display device such as a display, a sound output device such as a speaker, or the like. The navigation device 10 and the output device 20 may be connected to each other via a network or may be directly connected to each other. Further, the navigation device 10 may include the output device 20.

The navigation device 10 includes a content searching unit 101, a map database 102, a metadata database 103, a route searching unit 104, a content playback unit 105, a content database 106, a destination receiving unit 107, a selection receiving unit 108, and an output processing unit 109.

The content searching unit 101 searches, with reference to the metadata database 103, for video content related to a destination from among one or more pieces of video content depending on information indicating the destination received by the destination receiving unit 107. When the video content related to the destination is found by search, the content searching unit 101 outputs information on the video content to the output processing unit 109 as a content search result.

The content searching unit 101 includes a position acquiring unit 1011, a related location acquiring unit 1012, and a comparison unit 1013.

The position acquiring unit 1011 acquires the position of the destination based on the information indicating the destination received by the destination receiving unit 107 from the map database 102. The position of the destination is represented by, for example, latitude and longitude.

Further, the position acquiring unit 1011 acquires from the map database 102 the position of the location related to each piece of video content, the location being acquired by the related location acquiring unit 1012. The position of the location related to the video content is represented by, for example, latitude and longitude.

The video content is, for example, a movie, and the location related to the video content is, for example, a location of the movie. It should be noted that no limitation thereto is intended, and the video content may be, for example, a historical documentary, and the location related to the video content may be a historical site appearing in the historical documentary. The video content is only required to be video content related to a point, and the location related to the video content is only required to be a point related to the video content. The number of locations related to each piece of video content may be one or more.

The related location acquiring unit 1012 acquires, with reference to the metadata database 103, information on one or more locations related to each piece of video content.

The comparison unit 1013, on the basis of the position of the destination and the position of the location related to each piece of video content which are acquired by the position acquiring unit 1011, determines video content to which a location close to the destination is related, and sets the determined video content as a content search result. Specifically, for example, the comparison unit 1013 uses a latitude and longitude representing the position of the destination and a latitude and longitude representing the position of the location related to each piece of video content to calculate a distance from the destination to the location related to the corresponding piece of video content. When there is a location whose calculated distance is within a preset threshold value, the comparison unit 1013 determines the video content to which the location is related as the video content related to the destination, and sets it as a content search result. That is, the comparison unit 1013 determines that video content to which a location close to the destination is related is the video content related to the destination.

Alternatively, for example, the comparison unit 1013 may calculate a required time from the destination to a location related to video content by executing a route search between the destination and the location related to the video content. In this case, when there is a location whose calculated required time is within a predetermined threshold value, the comparison unit 1013 sets the video content to which the location is related as a content search result.

Here, it is assumed that the comparison unit 1013 determines that the video content to which the location close to the destination is related is the video content related to the destination, but a determination condition of the video content related to the destination is not limited to this. For example, the comparison unit 1013 may determine the video content related to the destination by determining the distance from the destination to the location related to each piece of video content and whether the location is a popular location. Specifically, the comparison unit 1013 acquires information on the number of visitors at the location related to the video content from a database (not shown) or the like, and when the number of visitors is larger than a predetermined number, the comparison unit 1013 determines that the location is a popular location. Then, the comparison unit 1013 may determine that the video content related to the location that is the popular location and whose distance or required time from the destination is within the threshold value is the video content related to the destination.

The comparison unit 1013 outputs the content search result to the output processing unit 109.

The map database 102 is a general map database that stores a facility name, an address of the facility or information on latitude and longitude of the facility, and the like.

The metadata database 103 stores metadata on one or more pieces of video content stored in the content database 106. The content of the metadata includes, for example, a title, performer, and summary of each piece of video content, a location related to each piece of video content, and a temporal position of a scene in which the related location appears in the corresponding video content. For example, when the video content is a movie, the content of the metadata includes a title, performer, and summary of the movie, a location at which each scene of the movie was shot, and a temporal position of a scene in which each location appears in the movie. In addition, for example, when the video content is a historical documentary, the content of the metadata includes a title, performer, and summary of the historical documentary, a location of a historical site appearing in the historical documentary, and a temporal position of a scene in which the historical site appears in the historical documentary.

The temporal position of the scene in which the related location appears in the video content represents the elapsed time from the start of playback of the video content to the scene in which the related location appears. For example, when information indicating 10 minutes is stored as a temporal position of a scene in which a location B appears in video content A, it means that the video of the scene in which the location B appears begins in ten minutes after start of playback of the video content A.

In addition, the title, performer, and summary of the video content are stored in the metadata database 103, for example, as text data.

On the basis of the information indicating the destination received by the destination receiving unit 107 and a content selection result received by the selection receiving unit 108, the route searching unit 104 refers to the map database 102 and the metadata database 103 to search for a guidance route to the destination using the location related to the selected video content as a waypoint. The route searching unit 104 outputs information on the searched guidance route to the output processing unit 109.

The route searching unit 104 includes a position acquiring unit 1041, a related location acquiring unit 1042, and a guidance route searching unit 1043.

The position acquiring unit 1041 acquires from the map database 102 the position of the destination based on the information indicating the destination received by the destination receiving unit 107. The position of the destination is represented by, for example, latitude and longitude.

Further, the position acquiring unit 1041 acquires from the map database 102 the position of the location related to the video content, the location being acquired by the related location acquiring unit 1042. The position of the location related to the video content is represented by, for example, latitude and longitude.

The related location acquiring unit 1042 acquires the content selection result received by the selection receiving unit 108. The related location acquiring unit 1042 refers to the metadata database 103 to acquire information on the location related to the video content indicated by the content selection result.

On the basis of the position of the destination acquired by the position acquiring unit 1041 and the position of the location related to the video content indicated by the content selection result acquired by the position acquiring unit 1041, the guidance route searching unit 1043 searches for the guidance route to the destination using the location as a waypoint.

The guidance route searching unit 1043 outputs the information on the searched guidance route to the output processing unit 109.

The content playback unit 105 acquires the content selection result received by the selection receiving unit 108. The content playback unit 105 acquires, from the content database 106, information on the video content indicated by the content selection result to perform playback processing. The content playback unit 105 outputs the video content after the playback processing to the output processing unit 109.

The content playback unit 105 includes a content acquiring unit 1051 and a playback processing unit 1052.

The content acquiring unit 1051 acquires video content from the content database 106 on the basis of the content selection result received by the selection receiving unit 108.

The playback processing unit 1052 performs playback processing on the video content acquired by the content acquiring unit 1051 and outputs it to the output processing unit 109.

The content database 106 stores one or more pieces of video content.

The destination receiving unit 107 receives information indicating a destination entered by a user. Specifically, the user inputs the name or the like of the destination using an input device (not shown) such as a mouse or a keyboard, and the destination receiving unit 107 receives the name or the like of the destination that the user has input using the input device, as information indicating the destination.

It should be noted that this is merely an example, and the user may use a microphone as the input device and input, for example, the name or the like of the destination by voice, or may use a touch panel as the input device and input the name or the like of the destination by touching the touch panel.

The destination receiving unit 107 outputs the received information indicating the destination to the content searching unit 101 and the route searching unit 104.

The selection receiving unit 108 receives information on one piece of video content selected by the user from among one or more pieces of video content displayed as a list on the output device 20. Specifically, the user checks the list showing the content search result and displayed on the output device 20 by the output processing unit 109, and selects one piece of video content by inputting information specifying desired video content by using the input device. As an input method, for example, the user may click on a name of desired video content from among the names of one or more pieces of video content displayed in the list, or may input a name of desired video content in a predetermined input field.

Note that this is merely an example, and the user may use a microphone as the input device and input, for example, information specifying desired video content by voice, or may use a touch panel as the input device and input information specifying desired video content by touching the touch panel.

The selection receiving unit 108 receives the information on the one piece of video content that the user has selected by input using the input device as a content selection result.

The selection receiving unit 108 outputs the content selection result to the route searching unit 104 and the content playback unit 105.

The output processing unit 109 causes the output device 20 to display the content search result output from the content searching unit 101 as a list. In the list, for one or more pieces of video content, information with which the user can check what each piece of video content is like, such as the name of each piece of video content, is displayed.

In addition, the output processing unit 109 causes the output device 20 to output a video or the like indicating the guidance route on the basis of the information on the guidance route output from the route searching unit 104, and at the same time, the output processing unit 109 causes the output device 20 to output the video content after being subjected to the playback processing by the content playback unit 105. The output processing unit 109 causes the output device 20 to output the guidance route and the video content as image or sound.

Note that, in the first embodiment, as shown in FIG. 1, the navigation device 10 includes the map database 102, the metadata database 103, and the content database 106, but no limitation thereto is intended. For example, the map database 102, the metadata database 103, or the content database 106 may be provided outside the navigation device 10. In this case, for example, the map database 102, the metadata database 103, or the content database 106 exists on the cloud via a communication interface. Any other configuration in which the navigation device 10 can refer to the map database 102, the metadata database 103, and the content database 106 may be used.

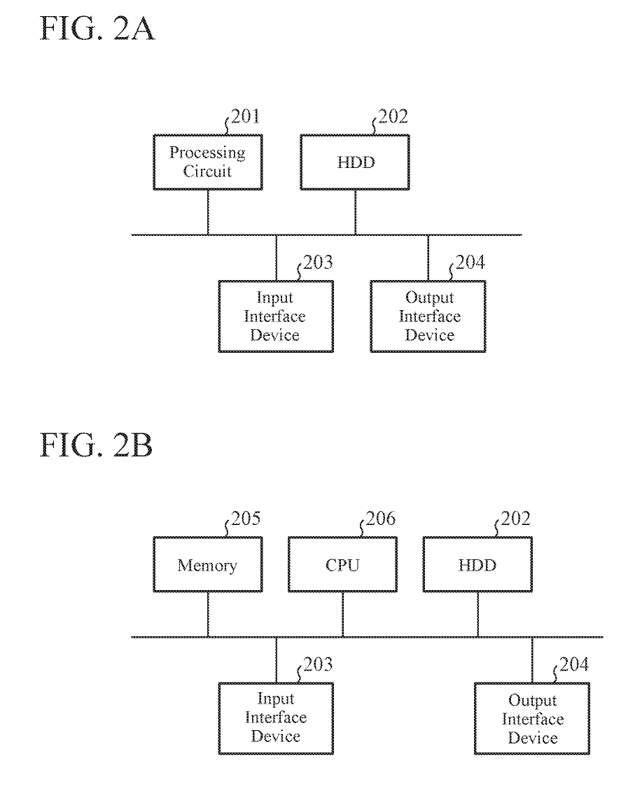

FIG. 2A and FIG. 2B are diagrams each showing an example of a hardware configuration of the navigation device 10 according to the first embodiment of the present invention.

In the first embodiment of the present invention, the functions of the content searching unit 101, the route searching unit 104, the content playback unit 105, the destination receiving unit 107, the selection receiving unit 108, and the output processing unit 109 are implemented by a processing circuit 201. That is, the navigation device 10 includes the processing circuit 201 for performing control of a process of searching for related video content on the basis of the received information indicating the destination, or a process of searching for the guidance route to the destination using the location related to the video content selected by the user among the searched video content as a waypoint.

The processing circuit 201 may be dedicated hardware as shown in FIG. 2A, or it may be a central processing unit (CPU) 206 which executes a program stored in a memory 205 as shown in FIG. 2B.

In a case where the processing circuit 201 is dedicated hardware, the processing circuit 201 may be, for example, a single circuit, a composite circuit, a programmed processor, a parallel-programmed processor, an application specific integrated circuit (ASIC), a field-programmable gate array (FPGA), or a combination thereof.

In a case where the processing circuit 201 is the CPU 206, the functions of the content searching unit 101, the route searching unit 104, the content playback unit 105, the destination receiving unit 107, the selection receiving unit 108, and the output processing unit 109 are implemented by software, firmware, or a combination of software and firmware. That is, the content searching unit 101, the route searching unit 104, the content playback unit 105, the destination receiving unit 107, the selection receiving unit 108, and the output processing unit 109 are implemented by the CPU 206 that executes a program stored in an hard disk drive (HDD) 202, the memory 205, or the like, or by a processing circuit such as a system large-scale integration (LSI). It can also be said that the program stored in the HDD 202, the memory 205, or the like causes a computer to execute procedures and methods which the content searching unit 101, the route searching unit 104, the content playback unit 105, the destination receiving unit 107, the selection receiving unit 108, and the output processing unit 109 use. Here, the memory 205 is, for example, a nonvolatile or volatile semiconductor memory, such as a random access memory (RAM), a read only memory (ROM), a flash memory, an erasable programmable read only memory (EPROM), and an electrically erasable programmable read-only memory (EEPROM), a magnetic disk, a flexible disk, an optical disk, a compact disk, a mini disk, a digital versatile disc (DVD), or the like.

Note that, some of the functions of the content searching unit 101, the route searching unit 104, the content playback unit 105, the destination receiving unit 107, the selection receiving unit 108, and the output processing unit 109 may be implemented by dedicated hardware and some of the functions thereof may be implemented by software or firmware. For example, the function of the content searching unit 101 can be implemented by the processing circuit 201 as dedicated hardware, and the functions of the route searching unit 104, the content playback unit 105, the destination receiving unit 107, the selection receiving unit 108, and the output processing unit 109 can be implemented by the processing circuit which reads and executes the program stored in the memory 205.

As the map database 102, the metadata database 103, and the content database 106, for example, the HDD 202 is used. Note that this is merely an example, and the map database 102, the metadata database 103, and the content database 106 may be configured by a DVD, the memory 205, or the like.

Further, the navigation device 10 has an input interface device 203 and an output interface device 204 that communicate with an external device such as the output device 20 or the input device.

In the above description, the hardware configuration of the navigation device 10 uses the HDD 202 as shown in FIG. 2B, but it may use a solid state drive (SSD) instead of the HDD 202.

The operation will be described.

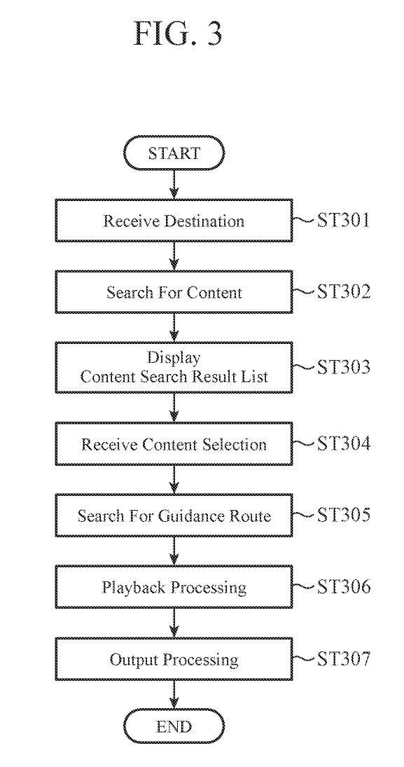

FIG. 3 is a flowchart illustrating the operation of the navigation device 10 according to the first embodiment of the present invention.

In the following description of the operation, as one example, it is assumed that the video content is one or more movies, and the location related to the video content is one or more locations in which each of the movies was shot.

The destination receiving unit 107 receives information indicating the destination input by the user (step ST301). The destination receiving unit 107 outputs the received information indicating the destination to the content searching unit 101 and the route searching unit 104.

The content searching unit 101 searches, with reference to the metadata database 103, for video content related to the destination depending on the information indicating the destination received by the destination receiving unit 107 (step ST302). Here, the content searching unit 101 searches for a movie corresponding to the information indicating the destination received by the destination receiving unit 107. As a result of the search, the content searching unit 101 outputs information on the extracted video content to the output processing unit 109 as a content search result.

It is assumed that the information indicating the destination received by the destination receiving unit 107 is information indicating one destination. That is, the user decides one destination and inputs information indicating the destination using the input device.

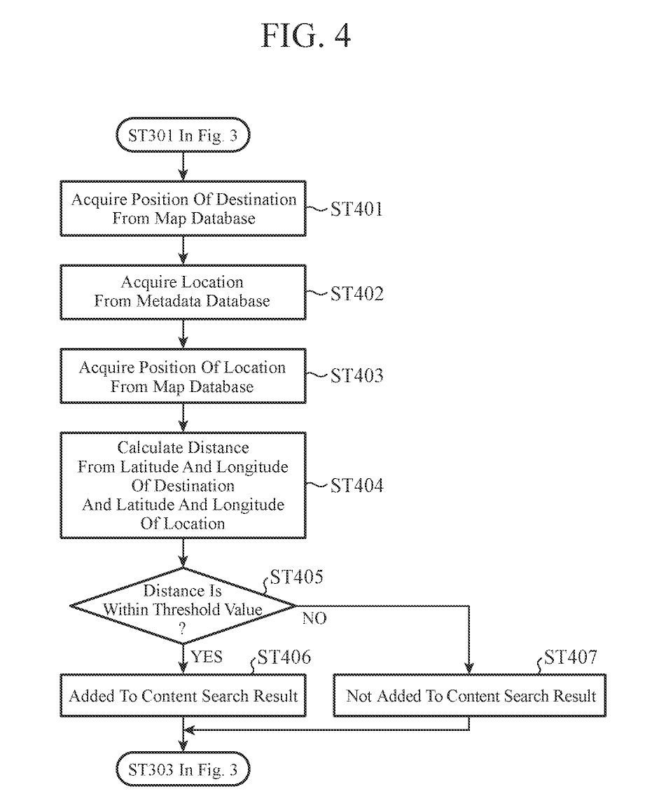

Here, FIG. 4 is a flowchart illustrating the details of the operation of the content searching unit 101 in step ST302 of FIG. 3.

The position acquiring unit 1011 acquires the position of the destination based on the information indicating the destination received by the destination receiving unit 107 from the map database 102 (step ST401).

The related location acquiring unit 1012 acquires, with reference to the metadata database 103, information on the location of each of the one or more movies (step ST402).

The position acquiring unit 1011 acquires from the map database 102 the positions of all the locations acquired by the related location acquiring unit 1012 in step ST402 (step ST403).

On the basis of the position of the destination acquired by the position acquiring unit 1011 in step ST401 and the position of each location acquired by the position acquiring unit 1011 in step ST402, the comparison unit 1013 calculates the distance between the destination and the corresponding location (step ST404). Specifically, the comparison unit 1013 calculates the distance between the destination and each location from the latitude and longitude of the destination and the latitude and longitude of the corresponding location.

The comparison unit 1013 determines whether the distance between the destination and each location calculated in step ST404 is within a preset threshold value (step ST405).

When it is determined in step ST405 that the distance between the destination and the current target location to be determined is within the preset threshold value (“YES” in step ST405), the comparison unit 1013 adds the movie that is the video content related to the current target location to the content search result (step ST406). Then, the comparison unit 1013 outputs the content search result to the output processing unit 109. Note that, the comparison unit 1013 may acquire information on the movie that is the video content related to the location with reference to the metadata database 103. Alternatively, in step ST402, when the related location acquiring unit 1012 acquires the information on the location, the related location acquiring unit 1012 also acquires information on the movie related to the location, and then the comparison unit 1013 may acquire the information on the movie related to the location from the related location acquiring unit 1012.

When it is determined in step ST406 that the distance between the destination and the current target location to be determined is not within the preset threshold value (“NO” in step ST405), the comparison unit 1013 does not add the movie that is the video content related to the current target location to the video content search result (step ST407).

The comparison unit 1013 performs the above-described operation of steps ST404 to ST407 on all the locations of all the movies acquired by the related location acquiring unit 1012 in step ST402. For each movie, when the distance between one of the locations of the movie and the destination is within the threshold value, the movie related to the one of the locations is added to the content search result. For each movie, when the distance between every location of the corresponding movie and the destination is larger than the threshold value, the movie is not added to the content search result.

In the above description, the comparison unit 1013 determines, on the basis of the distance between the destination and each location, whether to add a movie that is the video content related to the location acquired by the related location acquiring unit 1012 to the content search result. However, this is merely an example, and it may be determined whether to add a movie that is video content to the content search result on the basis of other conditions.

The description returns to the flowchart of FIG. 3.

When the content search result is output from the content searching unit 101 in step ST302, the output processing unit 109 causes the output device 20 to display the content search result output from the content searching unit 101 as a list (step ST303).

When the output processing unit 109 causes the output device 20 to display the content search result as a list, the selection receiving unit 108 receives information on a movie that is one piece of video content selected by the user, from the displayed list (step ST304). The selection receiving unit 108 outputs the received information on the movie as a content selection result to the route searching unit 104 and the content playback unit 105.

By referring to, on the basis of the information indicating the destination received by the destination receiving unit 107 in step ST301 and the content selection result received by the selection receiving unit 108 in step ST304, the map database 102 and the metadata database 103, the route searching unit 104 searches for a guidance route to the destination using the location related to the selected movie as a waypoint (step ST305). The route searching unit 104 outputs information on the searched guidance route to the output processing unit 109.

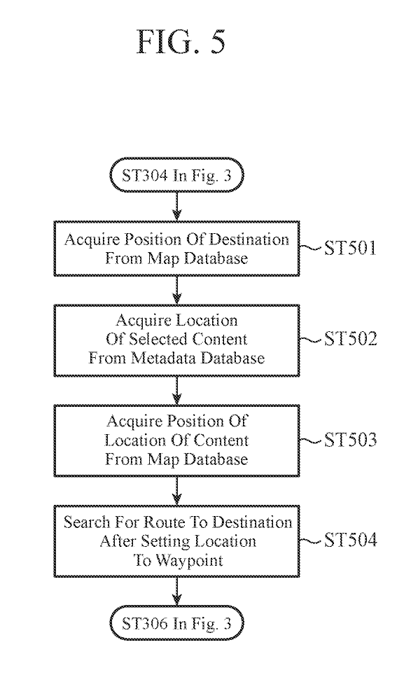

Here, FIG. 5 is a flowchart illustrating the details of the operation of the route searching unit 104 in step ST305 of FIG. 3.

The position acquiring unit 1041 acquires from the map database 102 the position of the destination based on the information indicating the destination received by the destination receiving unit 107 (step ST501).

By referring to, on the basis of the content selection result received by the selection receiving unit 108 in step ST304 in FIG. 3, the metadata database 103, the related location acquiring unit 1042 acquires information on the location related to the movie indicated by the content selection result (step ST502).

The position acquiring unit 1041 acquires the position of the location acquired by the related location acquiring unit 1042 in step ST502 from the map database 102 (step ST503).

On the basis of the position of the destination acquired by the position acquiring unit 1041 in step ST501 and the position of the location acquired by the position acquiring unit 1041 in step ST503, the guidance route searching unit 1043 searches for the guidance route to the destination using the location as a waypoint (step ST504). The guidance route searching unit 1043 outputs the information on the searched guidance route to the output processing unit 109. When the movie that is one piece of video content has, for example, a plurality of locations that are locations related to the one piece of video content, the guidance route searching unit 1043 selects, as a waypoint, only the location whose distance to the destination is determined, by the comparison unit 1013 of the content searching unit 101, to be within the threshold value in step ST405 of FIG. 4. Information on a comparison result of the distance to the destination may be acquired from the content searching unit 101.

In the above description, the position acquiring unit 1041 acquires the position of the destination and information on the location related to the movie indicated by the content selection result received by the selection receiving unit 108 (step ST501, step ST503). However, since the positions of the destination and the location are also acquired by the content searching unit 101 (see step ST401 and step ST403 in FIG. 4), the position acquiring unit 1041 does not necessarily have to acquire again and the guidance route searching unit 1043 may use the information acquired by the content searching unit 101.

In addition, in the operation as described above, for example, when acquiring the information on the location, the related location acquiring unit 1042 may acquire from the metadata database 103 the temporal position of a scene which is related to the location and in which the location appears (step ST502). Further, the guidance route searching unit 1043 may set a guidance route in which the time when the location is being passed through and the playback time of the scene in which the location appears are synchronized (step ST504).

Specifically, the guidance route searching unit 1043 calculates a passage time when the location is being passed through on the basis of the current time, the distance to the location, and the speed of the vehicle. The guidance route searching unit 1043 also calculates the playback time of the scene in which the location appears on the basis of the current time and the temporal position of the scene in which the location appears in the video content. Then, the guidance route searching unit 1043 sets a guidance route so that the calculated passage time and the calculated playback time are synchronized. The guidance route searching unit 1043 may acquire the speed of the vehicle from a vehicle speed sensor (not shown).

In addition, when the guidance route in which the passage time when the location is being passed through and the playback time of the scene in which the location appears are synchronized becomes a detour, the guidance route searching unit 1043 may confirm with the user whether to set the guidance route. Specifically, for example, the guidance route searching unit 1043 causes the output device 20 to display a message confirming whether to select a guidance route to take a detour, via the output processing unit 109, and the guidance route searching unit 1043 causes the input device (not shown) to receive an instruction from the user. Then, an input receiving unit receives the instruction from the user. When the input receiving unit receives an instruction to select a guidance route to take a detour, the guidance route searching unit 1043 may set the guidance route to take a detour so that the time when the location is being passed through and the playback time of the scene in which the location appears are synchronized.

In addition, in the above operation, for example, when there are a plurality of locations related to the video content, the related location acquiring unit 1042 may acquire information on all the locations related to the video content (step ST502), and the guidance route searching unit 1043 may search for the guidance route which is toward the destination via all the locations (step ST504). Note that, this is merely an example, and when there are a plurality of locations related to the video content, the guidance route searching unit 1043 may cause the output device 20 to display, for example, the plurality of locations as a list via the output processing unit 109, so that the user may select a location to be a waypoint. When the user selects a location, the input receiving unit receives information on the selected location and outputs it to the guidance route searching unit 1043, and the guidance route searching unit 1043 may search for the guidance route using the location selected by the user as a waypoint.

The description returns to the flowchart of FIG. 3.

On the basis of the content selection result received by the selection receiving unit 108 in step ST304, the content playback unit 105 acquires from the content database 106 the movie data that is the video content indicated by the content selection result, and then performs playback processing (step ST306). The content playback unit 105 outputs the video content after the playback processing to the output processing unit 109.

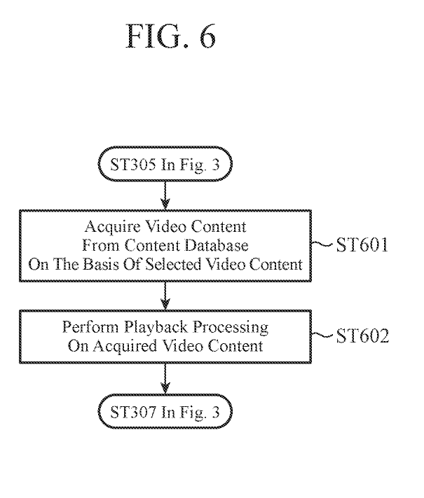

Here, FIG. 6 is a flowchart illustrating the details of the operation of the content playback unit 105 in step ST306 in FIG. 3.

On the basis of the content selection result received by the selection receiving unit 108 in step ST304, the content acquiring unit 1051 acquires the video content indicated by the content selection result from the content database 106 (step ST601).

The playback processing unit 1052 performs playback processing on the video content acquired by the content acquiring unit 1051 in step ST601 (step ST602). The playback processing unit 1052 outputs the video content subjected to the playback processing to the output processing unit 109.

The description returns to the flowchart of FIG. 3.

The output processing unit 109 causes the output device 20 to output the guidance route searched for by the route searching unit 104 in step ST305 and causes the output device 20 to output the video content subjected to the playback processing by the content playback unit 105 in step ST306 (step ST307). As a result, the guidance route via the location related to the destination desired by the user is presented to start route guidance, and provision of the video content related to the destination is started.

The output processing unit 109 may cause the output device 20 to display the guidance route as image or to output it as sound. Further, the output processing unit 109 may cause the output device 20 to display the video content only as image or to output it together with sound.

As described above, when the navigation device 10 searches for a guidance route to a destination entered by the user, the navigation device 10 acquires locations related to video content. Then, the navigation device 10 determines a location close to the destination among the acquired locations. Then, the navigation device 10 presents video content related to the location close to the destination to the user as video content related to the destination. Then, video content selected by the user from among the presented video content is received. Then, a guidance route in which location related to the selected video content is used as a waypoint is searched for and presented to the user, and the video content selected by the user and related to the destination is provided to the user.

Note that, for the operation described in FIG. 3, a case where the processing in step ST306 is performed after the processing in step ST305 is shown in the flowchart of FIG. 3, but no limitation thereto is intended. The processing in step ST305 and the processing in step ST306 may be executed in parallel, or the processing in step ST305 may be executed after the processing in step ST306.

As described above, the navigation device 10 according to the first embodiment is configured to include the destination receiving unit 107 for receiving information indicating a destination, the content searching unit 101 for searching for video content related to the destination based on the information indicating the destination depending on the information indicating the destination received by the destination receiving unit 107, the selection receiving unit 108 for receiving information on video content selected from among the video content searched for by the content searching unit 101, the route searching unit 104 for searching for a guidance route to the destination using a location related to the video content received by the selection receiving unit 108 as a waypoint, and the output processing unit 109 for outputting the guidance route searched for by the route searching unit 104 and outputting the video content received by the selection receiving unit 108 during output of the guidance route. Therefore, the navigation device 10 determines the video content related to the destination depending on the set destination, searches for and provides the guidance route in which the location related to the video content related to the destination is used as a waypoint, and also can provide the video content related to the destination. As a result, the user, when moving to the destination, can view the video content related to the destination and can pass through the location related to the video content. Therefore, the navigation device 10 can, for example, provide more entertainment than the simple movement to the user and can provide information obtained by effectively utilizing video content that can be played back by the navigation device 10 to the user moving on the guidance route.

Particularly, in recent years, technology related to automatic driving of vehicles has been developed, and as the automatic driving progresses, all the passengers of the vehicle including the driver will be able to enjoy the video content. From this point of view also, as described above, it is meaningful to enable providing information obtained by effectively utilizing video content that can be played back by the navigation device 10 to the user moving on the guidance route.

### Second Embodiment

In the first embodiment, the navigation device 10 searches for the video content related to the destination depending on the destination set by the user, and while playing back the searched video content, the navigation device 10 provides the guidance route which is toward the destination via the location related to the video content to the user.

In the second embodiment, an embodiment in which a navigation device 10a further has a function of editing video content and plays back the video content after editing the video content will be described.

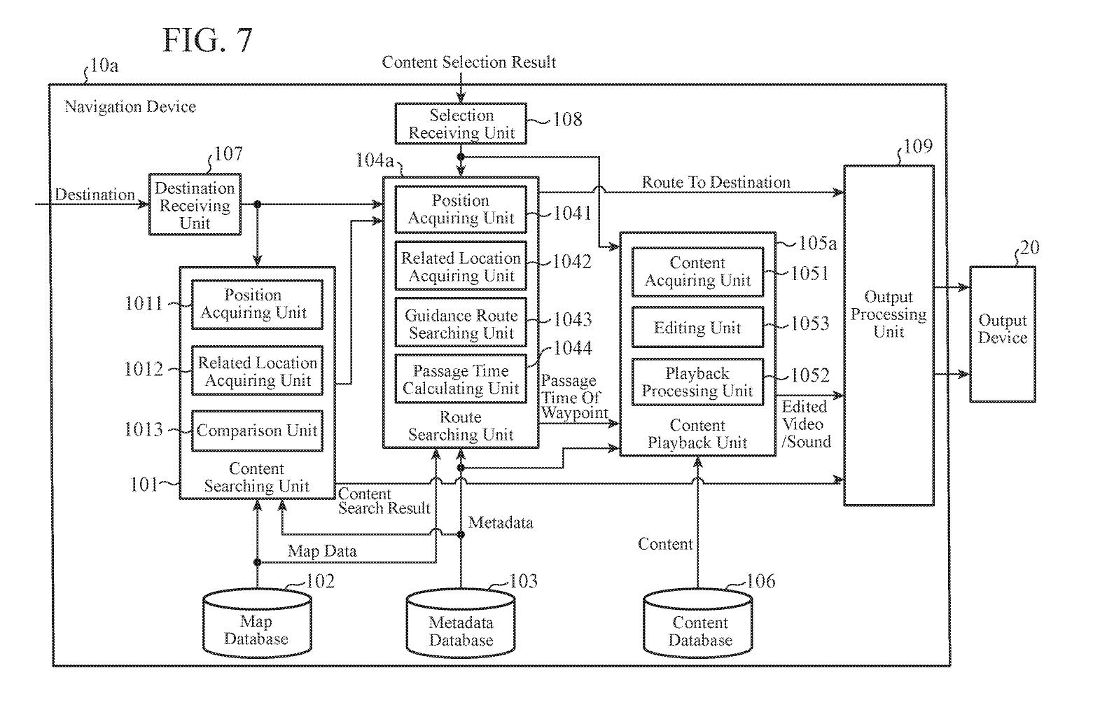

FIG. 7 is a configuration diagram of the navigation device 10a according to the second embodiment of the present invention.

As shown in FIG. 7, the navigation device 10a according to the second embodiment of the present invention differs from the navigation device 10 according to the first embodiment described with reference to FIG. 1 only in that a route searching unit 104a further includes a passage time calculating unit 1044, and that a content playback unit 105a further includes an editing unit 1053. Regarding other components, the same components as those of the navigation device 10 according to the first embodiment are denoted by the same reference numerals, and redundant description is omitted.

The passage time calculating unit 1044 of the route searching unit 104a calculates a passage time when a waypoint is being passed through in a guidance route to a destination searched for by the guidance route searching unit 1043.

Specifically, the passage time calculating unit 1044 calculates the passage time when the waypoint is being passed through on the basis of the current time, the distance to the waypoint, and the speed of the vehicle. The passage time calculating unit 1044 may acquire the current time from a clock that the navigation device 10a has therein, and may acquire the speed of the vehicle from the vehicle speed sensor (not shown).

The passage time calculating unit 1044 correlates the calculated passage time with information on the waypoint and outputs it to the content playback unit 105a.

The editing unit 1053 of the content playback unit 105a edits, on the basis of the video content acquired by the content acquiring unit 1051 and the passage time of the waypoint output by the route searching unit 104a, the video content so that the passage time of the waypoint and the playback time of the scene in which the waypoint appears in the video content coincide with each other.

The editing unit 1053 may acquire information on the temporal position of the scene in which the waypoint appears in the video content with reference to the metadata database 103, and calculate the time when the scene in which the waypoint appears in the video content is played back, on the basis of the acquired temporal position and the current time.

In addition, the editing unit 1053 edits the video content using a video editing technique such as that disclosed in JP 4812733 B, for example. Note that, this is merely an example, and the editing unit 1053 may edit the video content using an existing video editing technique.

Since the hardware configuration of the navigation device 10a according to the second embodiment of the present invention is similar to the hardware configuration described with reference to FIGS. 2A and 2B in the first embodiment, duplicate description will be omitted.

The operation will be described.

The operation of the navigation device 10a according to the second embodiment is different from the operation of the navigation device 10 described in the first embodiment with reference to FIG. 3 only in the specific operation content of steps ST305 and ST306. That is, only the specific operation described with reference to FIGS. 5 and 6 in the first embodiment is different. Therefore, hereinafter, only operation different from that in the first embodiment will be described, and duplicate description of operation similar to that in the first embodiment will be omitted.

In addition, in the following description of the operation, like the first embodiment, as one example, it is assumed that video content is one or more movies, and the location related to the video content is one or more locations of each of the movies.

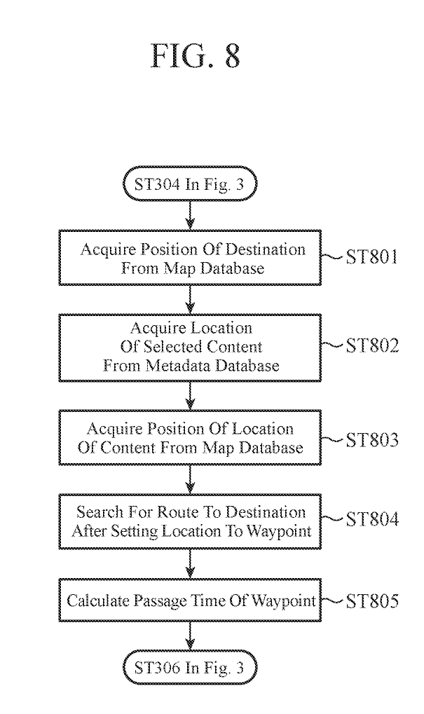

FIG. 8 is a flowchart illustrating the operation of the route searching unit 104a in the second embodiment.

That is, FIG. 8 is a flowchart illustrating the operation corresponding to step ST305 in FIG. 3 in detail.

In FIG. 8, since the specific operation of steps ST801 to ST804 is the same as the specific operation of steps ST501 to ST504 of FIG. 5 described in the first embodiment, duplicate description will be omitted.

The passage time calculating unit 1044 calculates the passage time when each location that is a waypoint is being passed through in the guidance route to the destination searched for by the guidance route searching unit 1043 in step ST804 (step ST805). The passage time calculating unit 1044 outputs the calculated passage time of each location to the content playback unit 105a.

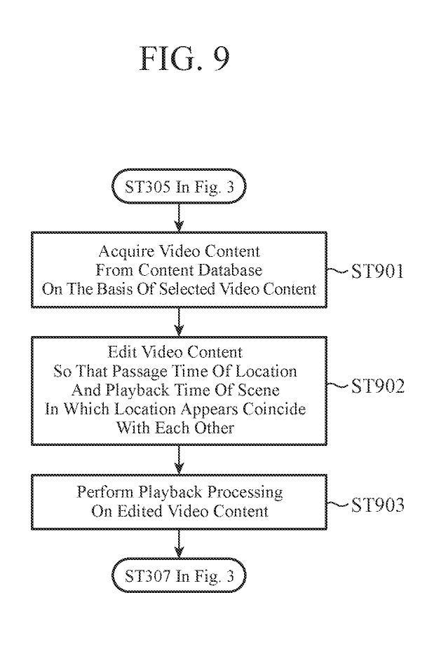

FIG. 9 is a flowchart illustrating the operation of the content playback unit 105a in the second embodiment.

That is, FIG. 9 is a flowchart illustrating the operation corresponding to step ST306 in FIG. 3 in detail.

In FIG. 9, since the specific operation of steps ST901 and ST903 is the same as that of steps ST601 and ST602 of FIG. 6 described in the first embodiment, duplicate description will be omitted.

On the basis of the video content acquired by the content acquiring unit 1051 in step ST901 and the passage time of each location output by the route searching unit 104a (refer to step ST805 in FIG. 8), the editing unit 1053 edits the video content so that the passage time of the corresponding location and the playback time of the scene in which the corresponding location appears in the video content coincide with each other (step ST902).

In step ST903, the playback processing unit 1052 performs playback processing on the video content edited by the editing unit 1053 in step ST902.

As described above, the navigation device 10a of the second embodiment further includes, in addition to the navigation device 10 of the first embodiment, the passage time calculating unit 1044 that calculates a passage time when the waypoint is being passed through in the guidance route to the destination, and the editing unit 1053 that acquires the video content received by the selection receiving unit 108, and for the acquired video content, edits the video content so that the playback time of the scene in which the waypoint appears and the passage time of the waypoint calculated by the passage time calculating unit 1044 coincide with each other, and the output processing unit 109 is configured to output the video content after being edited by the editing unit 1053. As a result of this, the navigation device 10a plays back the scene in which each waypoint appears when the corresponding waypoint is being passed through. Thus, it is possible to provide information obtained by utilizing the video content to the user more effectively than the first embodiment. In addition, at that time, the scenes included in the video content to be played back are edited on the basis of the set route. Thus, compared with the case of setting a route on the basis of the scenes included in the video content, increase in the time required for the movement to the destination can be suppressed.

### Third Embodiment

In the first and second embodiments, the case where the navigation device 10 or 10a according to the present invention is used in an in-vehicle navigation device, which performs route guidance to a vehicle, has been described.

In the third embodiment, an embodiment will be described in which, in a car navigation system having an in-vehicle device, a server, and a mobile information terminal that can cooperate with each other, the server or the mobile information terminal has functions of the navigation device according to the present invention.

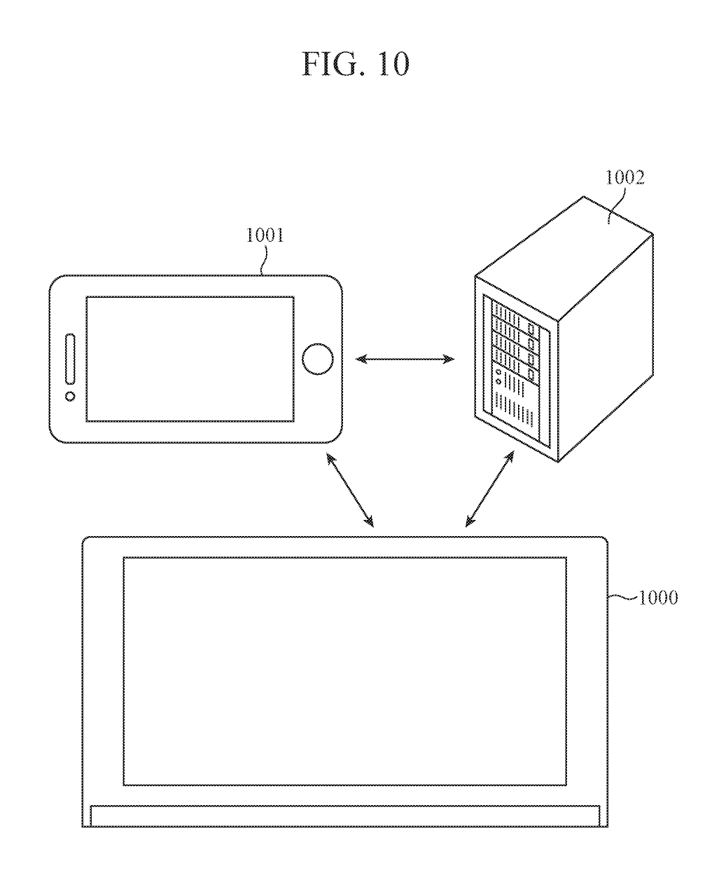

FIG. 10 is a diagram showing an outline of the car navigation system in the third embodiment of the present invention.

This car navigation system has an in-vehicle device 1000, a mobile information terminal 1001, and a server 1002. The mobile information terminal 1001 may be in any form such as a smartphone, a tablet PC, a mobile phone, or the like.

Hereinafter, first as an example, a case will be described in which the server 1002 has a navigation function and a playback processing function of video content, and information on the guidance route and the video content after playback processing are provided to the user by transmitting them from the server 1002 to the in-vehicle device 1000 to be displayed. Next, as another example, a case will be described in which the mobile information terminal 1001 has a navigation function and a playback processing function of video content, and information on the guidance route and the video content after playback processing are provided to the user by causing the in-vehicle device 1000 to display them.

First, a case will be described in which the server 1002 has a navigation function and a playback processing function of video content, and the server 1002 transmits information on the guidance route and the video content after playback processing to the in-vehicle device 1000 to be displayed.

In this case, the server 1002 functions as the navigation device 10 or 10a including the content searching unit 101, the map database 102, the metadata database 103, the route searching unit 104 or 104a, the content playback unit 105 or 105a, the content database 106, the destination receiving unit 107, and the selection receiving unit 108, which are described in the above-described first or second embodiment.

In addition, the in-vehicle device 1000 has a communication function for communicating with the server 1002, and also has at least a display unit or a sound output unit for providing the user with information on the guidance route and the video content after the playback processing received from the server 1002 to function as the output device 20. The communication function of the in-vehicle device 1000 may be any one as long as it can directly communicate with the server 1002 or can communicate with the server 1002 via the mobile information terminal 1001. Further, the in-vehicle device 1000 may have an input device for the user to input information.

The server 1002 acquires information indicating a destination, a content selection result, and information such as the current position of the vehicle from the vehicle and transmits a content search result, information on the guidance route, and video content after the playback processing to the vehicle.

The in-vehicle device 1000 receives the information on the guidance route and the video content after the playback processing from the server 1002, and provides them to the user.

Next, a case will be described in which the mobile information terminal 1001 has a navigation function and a playback processing function of video content, and the mobile information terminal 1001 transmits information on the guidance route and the video content after playback processing to the in-vehicle device 1000 to be displayed.

In this case, the mobile information terminal 1001 functions as the navigation device 10 or 10a including the content searching unit 101, the route searching unit 104 or 104a, the content playback unit 105 or 105a, the destination receiving unit 107, and the selection receiving unit 108, which are described in the above-described first or second embodiment.

In addition, here, it is assumed that the server 1002 has the map database 102, the metadata database 103, and the content database 106, and also has a communication function with the mobile information terminal 1001. Note that, the map database 102, the metadata database 103, and the content database 106 may be included in the mobile information terminal 1001.

In addition, the in-vehicle device 1000 has a communication function for communicating with the mobile information terminal 1001, and also has at least a display unit or a sound output unit for providing the user with information on the guidance route and the video content after the playback processing received from the mobile information terminal 1001 to function as the output device 20.

The mobile information terminal 1001 acquires information indicating a destination and a content selection result, for example, from an input device (not shown) of the mobile information terminal 1001, acquires information such as the current position of the vehicle from the vehicle, and transmits a content search result, information on the guidance route, and video content after the playback processing to the vehicle. At that time, the mobile information terminal 1001 communicates also with the server 1002, and performs necessary processing with reference to the map database 102, the metadata database 103, and the content database 106 in the server 1002.

The server 1002 communicates with the mobile information terminal 1001, and provides information in the map database 102, the metadata database 103, and the content database 106.

The in-vehicle device 1000 receives the information on the guidance route and the video content after the playback processing from the mobile information terminal 1001 and provides them to the user.

Even with the configuration as in the third embodiment, the same effects as in the first and second embodiments can be obtained.

In the third embodiment, the embodiment is described in which, in a car navigation system having an in-vehicle device, a server, and a mobile information terminal which can cooperate with each other, the server or the mobile information terminal has functions of the navigation device according to the present invention.

However, no limitation to these embodiments is intended, and an embodiment may be adopted in which a plurality of functions of the navigation device of the present invention are divided between the in-vehicle device, the server, and the mobile information terminal. Which one of the in-vehicle device, the server, and the mobile information terminal has any of the plurality of functions can be freely set as long as the functions of the navigation device of the present invention can be implemented.

In the first to third embodiments, the case in which the navigation device according to the present invention is used in a navigation device that performs route guidance to a vehicle has been described. However, the navigation device of the present invention is not limited to the one that performs route guidance to a vehicle, but may be the one that performs route guidance to a moving object such as a person, a train, a ship, or an aircraft.

It should be noted that the invention of the present application can freely combine the embodiments, modify any component of the embodiments, or omit any component in the embodiments within the scope of the invention.

### INDUSTRIAL APPLICABILITY

The navigation device according to the present invention is configured to be able to provide information obtained by effectively utilizing video content that can be played back by the navigation device to a user moving on the guidance route. Therefore, the navigation device according to the present invention can be used in a navigation device and the like which can provide video content to a user.

### REFERENCE SIGNS LIST

10, 10a: Navigation device, 20: Output device, 101: Content searching unit, 102: Map database, 103: Metadata database, 104, 104a: Route searching unit, 105, 105a: Content playback unit, 106: Content database, 107: Destination receiving unit, 108: Selection receiving unit, 201: Processing circuit, 202: HDD, 203: Input interface device, 204: Output interface device, 205: Memory, 206: CPU, 1011, 1041: Position acquiring unit, 1012, 1042: Related location acquiring unit, 1013: Comparison unit, 1043: Guidance route searching unit, 1044: Passage time calculating unit, 1051: Content acquiring unit, 1052: Playback processing unit, 1053: Editing unit, 1000: In-vehicle device, 1001: Mobile information terminal, 1002: Server.

1. A navigation device comprising:
a processor to execute a program; and
a memory to store the program which, when executed by the processor, performs processes of,
receiving information indicating a destination;
searching, by using metadata including information on a location related to video content and a temporal position of a scene in which the related location appears, for one or more pieces of video content related to the destination based on the information indicating the destination depending on the received information indicating the destination;
receiving information on one piece of video content selected from among the one or more pieces of video content searched for;
searching for a guidance route to the destination using one or more locations related to the video content whose information is received as waypoints; and
outputting the guidance route searched for and outputting the video content whose information is received during output of the guidance route.

2. The navigation device according to claim 1, wherein the processes further include acquiring the video content whose information is received and performing playback processing on the acquired video content, and
outputting the video content after being subjected to the playback processing.

3. The navigation device according to claim 1, wherein the processes further include:
acquiring information on one or more locations related to video content;
acquiring a position of the destination based on the received information indicating the destination and a position of each of the one or more locations whose information is acquired; and
determining video content related to the destination on a basis of the position of the destination and the position of each of the one or more locations related to the video content.

4. The navigation device according to claim 3, wherein the processes further include
calculating a distance from the destination to each of the one or more locations related to the video content, and determining that video content whose calculated distance is within a threshold value is video content related to the destination.

5. The navigation device according to claim 3, wherein the processes further include
calculating a required time from the destination to each of the one or more locations related to the video content, and determining that video content whose calculated required time is within a threshold value is video content related to the destination.

6. The navigation device according to claim 1, wherein the processes further include
searching for the guidance route so that a playback time of a scene in which one of the locations related to the video content appears in the video content whose information is received and a passage time when the one of the locations related to the video content is being passed through synchronize with each other.

7. The navigation device according to claim 6, wherein the processes further include receiving an instruction for whether synchronization is required or not between the playback time of the scene in which the one of the locations related to the video content appears and the time when the one of the locations related to the video content is being passed through, and
searching, when an instruction that synchronization is required has been received, for the guidance route so that the playback time of the scene in which the one of the locations related to the video content appears in the video content whose information is received and the time when the one of the locations related to the video content is being passed through synchronize with each other.

8. The navigation device according to claim 1, wherein the processes further include
searching, when there are a plurality of locations related to the video content whose information is received, for the guidance route using some or all of the plurality of locations as waypoints.

9. The navigation device according to claim 8, wherein the processes further include receiving a selection of a location to be a waypoint among the plurality of locations, and
searching for the guidance route using the location received as a waypoint.

10. The navigation device according to claim 1, wherein the processes further include:
calculating a passage time when one of the waypoints is being passed through in the guidance route to the destination;
acquiring the video content whose information is received, and for the acquired video content, editing the video content so that a playback time of a scene in which the one of the waypoints appears and the passage time of the one of the waypoints calculated coincide with each other; and
outputting the video content after being edited.

11. The navigation device according to claim 1, wherein the processes further include
searching for the one or more pieces of video content related to the destination on a basis of content metadata acquired from outside the navigation device,
searching for the guidance route to the destination on a basis of map data acquired from outside the navigation device, and
outputting video content that is acquired from content data acquired from outside the navigation device and whose information is received.

12. A navigation method comprising:
receiving information indicating a destination;
searching, by using metadata including information on a location related to video content and a temporal position of a scene in which the related location appears, for one or more pieces of video content related to the destination based on the information indicating the destination depending on the received information indicating the destination;
receiving information on one piece of video content selected from among the one or more pieces of video content searched for;
searching for a guidance route to the destination using one or more locations related to the video content whose information is received as waypoints; and
outputting the guidance route searched for and outputting the video content whose information is received during output of the guidance route.
